(19) United States
(12) Patent Application Publication
(10) Pub. No.: US 2026/0020103 A1
(43) Pub. Date: Jan. 15, 2026

(54) COMMUNICATION SYSTEM, CONTROL TERMINAL, CONTROL METHOD, AND RECORDING MEDIUM

(71) Applicant: Panasonic Intellectual Property Management Co., Ltd., Osaka (JP)

(72) Inventors: Kosuke KAMEDA, Osaka (JP); Yuta TOMIO, Osaka (JP); Kazuma NISHIYASU, Nara (JP)

(21) Appl. No.: 19/236,534

(22) Filed: Jun. 12, 2025

(30) Foreign Application Priority Data
Jul. 9, 2024 (JP) 2024-110073

(51) Int. Cl. H04W 76/30; H04W 84/18

(52) U.S. Cl. CPC H04W 76/30; H04W 84/18

(57) ABSTRACT

A communication system and the like which can cause a communication device to more easily withdraw from a mesh network are provided. The communication system includes: a plurality of devices that form a mesh network, and perform wireless communication in a first wireless communication mode in the mesh network; and a control terminal, the control terminal: connects to a first device among the plurality of devices by wireless communication in a second wireless communication mode different from the first wireless communication mode; and transmits, to the first device, a withdrawal request signal for causing a second device different from the first device among the plurality of devices to withdraw from the mesh network, and when the second device receives the withdrawal request signal from the first device via the mesh network, the second device withdraws from the mesh network.

### CROSS REFERENCE TO RELATED APPLICATION

This application claims the benefit of priority of Japanese Patent Application Number 2024-110073, filed on Jul. 9, 2024, the entire content of which is hereby incorporated by reference.

### TECHNICAL FIELD

The present disclosure relates to a communication system, a control terminal, a control method, and a recording medium.

### BACKGROUND ART

Japanese Unexamined Patent Application Publication No. 2023-121394 discloses a technique for causing a communication device which has already joined a mesh network to withdraw from the mesh network.

### SUMMARY

In order to cause a plurality of communication devices to withdraw from a mesh network, it is necessary to identify the communication devices which are caused to withdraw and to perform communication. This takes time and effort.

An object of the present disclosure is to provide a communication system, a control terminal, a control method, and a recording medium which can cause a communication device to more easily withdraw from a mesh network.

A communication system according to an aspect of the present disclosure includes: a plurality of devices that form a mesh network, and perform wireless communication in a first wireless communication mode in the mesh network; and a control terminal, the control terminal: connects to a first device among the plurality of devices by wireless communication in a second wireless communication mode different from the first wireless communication mode; and transmits, to the first device, a withdrawal request signal for causing a second device different from the first device among the plurality of devices to withdraw from the mesh network, and when the second device receives the withdrawal request signal from the first device via the mesh network, the second device withdraws from the mesh network. A control terminal according to an aspect of the present disclosure includes: a wireless communicator; and a controller, and using the wireless communicator, the controller: connects to a first device among a plurality of devices by wireless communication in a second wireless communication mode different from a first wireless communication mode, the plurality of devices forming a mesh network and performing wireless communication in the first wireless communication mode in the mesh network; and transmits, to the first device, a withdrawal request signal for causing a second device different from the first device among the plurality of devices to withdraw from the mesh network.

A control method according to an aspect of the present disclosure includes: connecting, by a control terminal, to a first device among a plurality of devices by wireless communication in a second wireless communication mode different t wireless communication mode, the plurality of devices forming a mesh network and performing wireless communication in the first wireless communication mode in the mesh network; transmitting, by the control terminal, to the first device, a withdrawal request signal for causing a second device different from the first device among the plurality of devices to withdraw from the mesh network; and withdrawing, by the second device, from the mesh network when the second device receives the withdrawal request signal from the first device via the mesh network.

A control method according to an aspect of the present disclosure is a control method performed by a control terminal, and the control method includes: connecting to a first device among a plurality of devices by wireless communication in a second wireless communication mode different from a first wireless communication mode, the plurality of devices forming a mesh network and performing wireless communication in the first wireless communication mode in the mesh network; and transmitting, to the first device, a withdrawal request signal for causing a second device different from the first device among the plurality of devices to withdraw from the mesh network.

The present disclosure can be realized not only as the control method described above but also a non-transitory computer-readable recording medium having stored therein a program for causing a computer to execute the control method.

A communication system, a control method, and a recording medium according to the present disclosure can cause a communication device to more easily withdraw from a mesh network.

### BRIEF DESCRIPTION OF THE DRAWINGS

The figures depict one or more implementations in accordance with the present teaching, by way of examples only, not by way of limitations. In the figures, like reference numerals refer to the same or similar elements.

FIG. 1 is a block diagram showing the functional configuration of a communication system according to an embodiment.

FIG. 2 is a network diagram of the communication system according to the embodiment.

FIG. 3 is a flowchart illustrating the operation of a device in the embodiment.

FIG. 4 is a flowchart illustrating operation example 1 of a control terminal according to the embodiment.

FIG. 5 is a flowchart illustrating operation example 2 of the control terminal according to the embodiment.

FIG. 6 is a flowchart illustrating the operation of a variation of the control terminal according to the embodiment.

### DETAILED DESCRIPTION

### Embodiment

A communication system, a control terminal, a control method, and a recording medium according to an embodiment of the present disclosure will be described in detail below with reference to drawings. The embodiment described below indicates a specific example of the present disclosure. Numerical values, constituent elements, the arrangement and connection of the constituent elements, steps, the order of the steps, and the like shown in the following embodiment are examples, and are not intended to limit the present disclosure. Among the constituent elements in the following embodiment, constituent elements which are not recited in the independent claims are described as optional constituent elements in a form.

The drawings each are schematic diagrams, and are not exactly shown. In the drawings, substantially the same configurations are identified with the same reference signs, and repeated description may be omitted or simplified.

### [Configuration]

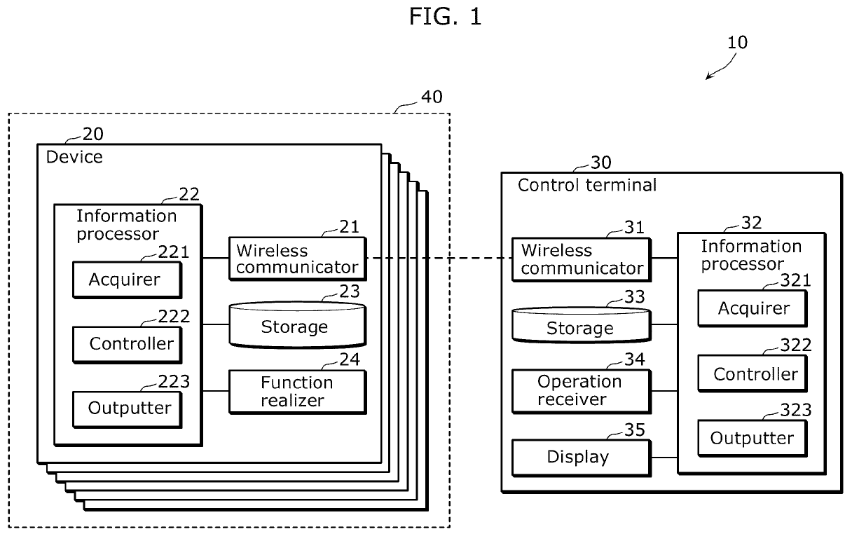

The configuration of the communication system according to the embodiment will first be described. FIG. 1 is a block diagram showing the functional configuration of communication system 10 according to the embodiment. As shown in FIG. 1, communication system 10 includes a plurality of devices 20 and control terminal 30.

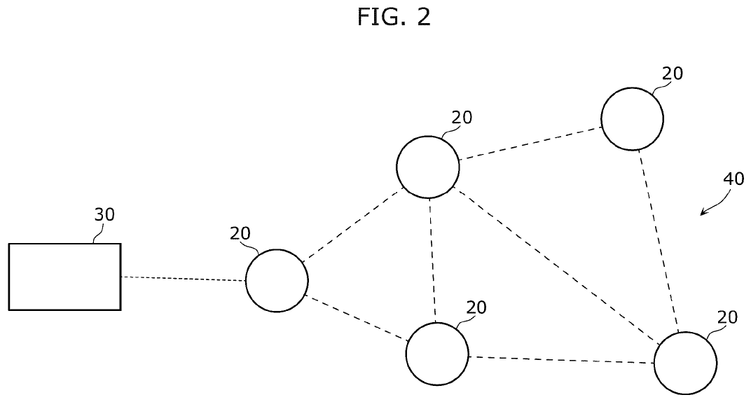

In communication system 10, each of devices 20 has a wireless communication function, and the communication devices form mesh network 40. FIG. 2 is a schematic diagram of the network in communication system 10 according to the embodiment. Each circle in FIG. 2 corresponds to one device 20 (in other words, a communication node). In mesh network 40, when information is transmitted from a certain communication node (which is also referred to as a first communication node) to another communication node (which is also referred to as a second communication node), the information is transmitted in, for example, a routing mode, but may be transmitted in another mode such as a flooding mode.

In mesh network 40, a communication path is set which can distribute information to communication nodes belonging to mesh network 40 in advance. When the first communication node transmits, in a unicast mode, information including the address information (destination information) of the second communication node based on the set communication path, the other communication nodes that have received this information and belong to mesh network 40 identical to the first communication node further transmit the received information in the unicast mode based on the set communication path. In other words, the other communication nodes relay the information. The relay of the information as described above is repeated in identical mesh network 40, and thus the second communication node can receive the information transmitted by the first communication node.

The first communication node may broadcast the information including the address information (destination information) of the second communication node, and each of the other communication nodes that have received this information and belong to mesh network 40 identical to the first communication node may relay the received information and further broadcast the received information. The relay of the information as described above is repeated in identical mesh network 40, and thus the information transmitted by the first communication node is distributed to all the communication nodes belonging to mesh network 40 identical to the first communication node. Hence, the second communication node can receive the information transmitted by the first communication node.

The information transmitted via mesh network 40 is, for example, a withdrawal request signal for causing device 20 to withdraw from mesh network 40. For example, when device 20 is a lighting fixture, the information transmitted via mesh network 40 is control information for performing lighting control, extinction control, or dimming control on the lighting fixture. When mesh network 40 includes an environmental sensor, the measurement value (sensing information) of the environmental sensor may be transmitted.

In communication system 10, wireless communication between devices 20 (hereinafter also simply referred to as communication) is performed according to, for example, a first communication protocol for mesh network 40. The first communication protocol is, for example, Bluetooth (registered trademark) mesh. The first communication protocol is an example of a first wireless communication mode.

On the other hand, since control terminal 30 indicated by a rectangle in FIG. 2 does not belong to mesh network 40, control terminal 30 cannot communicate with devices 20 using the first communication protocol. However, control terminal 30 has a communication function using a second communication protocol for one-to-one communication. The second communication protocol is a communication protocol different from the first communication protocol, and is, for example, Bluetooth (registered trademark) Low Energy (BLE). The first communication protocol and the second communication protocol may use the same frequency band (for example, a 2.4 GHz band). The second communication protocol is an example of a second wireless communication mode.

Device 20 will first be described. Device 20 may be a device which can communicate with a device other than device 20, and device 20 is, for example, a lighting fixture. For example, device 20 may be a scheduler, an environmental sensor, a camera, or the like.

The lighting fixture which is an example of device 20 will be further described. The lighting fixture is a base light or the like which is installed on the ceiling of an indoor space and illuminates the indoor space. As described above, each of a plurality of lighting fixtures which are devices 20 has a wireless communication function. The lighting fixtures join mesh network 40 (more specifically, a wireless mesh network) to form mesh network 40. The form of the lighting fixture is not particularly limited, and may be a celling light, a down light, a spot light, or the like.

Specifically, device 20 includes wireless communicator 21, information processor 22, storage 23, and function realizer 24.

Wireless communicator 21 is a wireless communication circuit for wireless communication with other devices 20 and control terminal 30 performed by device 20. After device 20 joins mesh network 40, wireless communicator 21 can perform communication via mesh network 40. Before device 20 joins mesh network 40, wireless communicator 21 periodically transmits a beacon signal (which is also referred to as an advertisement signal or the like), and individually performs wireless communication with control terminal 30 which has received the beacon signal. The communication standard of the wireless communication performed by wireless communicator 21 is specifically BLE, Bluetooth (registered trademark) mesh or the like.

Information processor 22 executes information processing and the like for operating device 20. Information processor 22 controls function realizer 24 to operate device 20. Information processor 22 is realized, for example, by a microcomputer, but may be realized by a processor or a dedicated circuit. The hardware, such as a microcomputer or a processor, of information processor 22 executes a computer program (software) stored in storage 23, and thus the function of information processor 22 is realized. Specifically, information processor 22 includes acquirer 221, controller 222, and outputter 223.

Acquirer 221 acquires the withdrawal request signal and the like.

Controller 222 controls device 20 based on the withdrawal request signal and the like acquired by acquirer 221.

Outputter 223 transmits the withdrawal request signal acquired by acquirer 221 to other devices 20.

Storage 23 is a storage device in which information necessary for information processing on a computer program and the like executed by information processor 22 is stored. Storage 23 is realized, for example, by a semiconductor memory. The computer program stored in storage 23 includes a dedicated application program for causing device 20 to transmit the withdrawal request signal via mesh network 40.

Function realizer 24 is a device for realizing the function of device 20 in the operation of device 20. Function realizer 24 is controlled by information processor 22. For example, when device 20 is a lighting device, function realizer 24 is a light source. The light source emits white light into an indoor space such that device 20 serving as the lighting device illuminates the indoor space. The light source is realized, for example, by a light emitting diode (LED) element, but may be realized by another light emitting element such as a semiconductor laser, an organic electro luminescence (EL), or an inorganic EL.

Control terminal 30 will then be described. Control terminal 30 is an information terminal which is used so that a user causes device 20 to join or withdraw from mesh network 40 to construct mesh network 40 using devices 20. Control terminal 30 is also used so that the user sets devices 20 which form mesh network 40. Control terminal 30 is also used so that the user controls devices 20 which form mesh network 40. The user here is, for example, an installer who has performed an installation operation on devices 20, but may be another user other than the installer. The user may be, for example, an administrator of communication system 10 or the like.

Control terminal 30 is, for example, a portable terminal such as a smartphone, a tablet terminal, or a personal digital assistant (PDA). Control terminal 30 may be a dedicated remote controller which is used in communication system 10. Specifically, control terminal 30 includes wireless communicator 31, information processor 32, storage 33, operation receiver 34, and display 35.

Wireless communicator 31 is a communication circuit for communication (more specifically, wireless communication) with devices 20 performed by control terminal 30. The communication standard of the communication performed by wireless communicator 31 is, for example, BLE.

Information processor 32 executes information processing according to an operation of the user received by control terminal 30 via operation receiver 34. For example, information processor 32 executes information processing on processing for causing device 20 to withdraw from mesh network 40. Here, an example of the processing for causing device 20 to withdraw is to change or delete setting information which is stored in storage 23 of device 20 when device 20 joins mesh network 40. The setting information is information necessary for communication in mesh network 40. Information processor 32 is realized, for example, by a microcomputer, but may be realized by a processor or a dedicated circuit. The hardware, such as a microcomputer or a processor, of information processor 32 executes a computer program (software) stored in storage 33, and thus the function of information processor 32 is realized. Specifically, information processor 32 includes acquirer 321, controller 322, and outputter 323.

Acquirer 321 acquires an operation of the user received by operation receiver 34 and the like.

Controller 322 executes information processing so that control terminal 30 causes device 20 to withdraw from mesh network 40, and the like.

Outputter 323 outputs the withdrawal request signal.

Storage 33 is a storage device in which information necessary for information processing on a computer program and the like executed by information processor 32 is stored. Storage 33 is realized, for example, by a semiconductor memory or the like. The computer program stored in storage 33 includes a dedicated application program for causing control terminal 30 to transmit the withdrawal request signal for causing device 20 to withdraw from mesh network 40.

Operation receiver 34 receives an operation performed by the user. Operation receiver 34 is realized, for example, by a touch panel or the like.

Display 35 displays various types of images. The various types of images are, for example, images necessary for processing for causing device 20 to join mesh network 40 and processing for causing device 20 to withdraw from mesh network 40. Display 35 is realized, for example, by a display panel such as a liquid crystal panel or an organic EL panel.

### [Operation]

The operation of communication system 10 according to the embodiment will then be described. In general, in order to cause device 20 to withdraw from mesh network 40, control terminal 30 connects to device 20 which is caused to withdraw by communication in the second wireless communication mode, transmits the withdrawal request signal to device 20, and then releases the communication connection to device 20. In the general operation as described above, in order to cause a plurality of devices 20 to withdraw, it is necessary to repeatedly perform the communication connection and the release of the communication connection, and this takes time.

By contrast, in communication system 10, in a state where control terminal 30 connects to arbitrary one device 20 by the communication in the second wireless communication mode, control terminal 30 transmits the withdrawal request signal to target devices 20 via mesh network 40 with the one device used as a starting point. In this way, it is possible to cause devices 20 to withdraw from mesh network 40 without the user directly connecting to devices 20 of withdrawal targets in the second wireless communication mode.

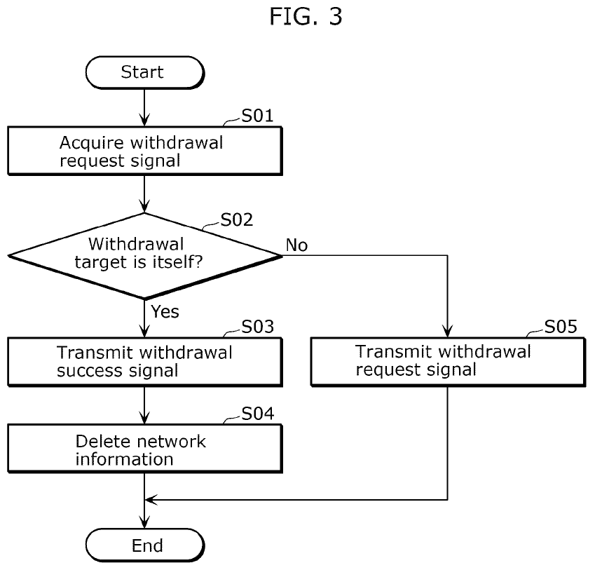

The operation of device 20 when the withdrawal request signal is transmitted will first be described. FIG. 3 is a flowchart illustrating the operation of device 20 in the embodiment.

Acquirer 221 of device 20 first acquires the withdrawal request signal (S01). The withdrawal request signal is a signal for causing a withdrawal target device to withdraw from mesh network 40, and includes information for identifying the withdrawal target device such as the identification number of the withdrawal target device. The withdrawal target device is an example of a second device.

When acquirer 221 acquires the withdrawal request signal, controller 222 of device 20 determines whether the target (destination) of the acquired withdrawal request signal is device 20 (S02). For example, controller 222 checks the identification number of the withdrawal target device included in the withdrawal request signal against the identification number of device 20 to determine whether the target of the acquired withdrawal request signal is device 20.

When the target of the withdrawal request signal is determined to be device 20 (Yes in S02), that is, when the withdrawal target device is determined to be device 20, controller 222 causes device 20 to withdraw from mesh network 40.

When device 20 withdraws from mesh network 40, outputter 223 transmits a withdrawal success signal to control terminal 30 via mesh network 40 (S03). Controller 222 deletes network information stored in storage 23 (S04). The network information deleted here includes the network ID of mesh network 40, the address information of device 20 used in communication in mesh network 40, and the like. The network information deleted may further include information used for the operation of the withdrawal target device in mesh network 40 such as control group setting information indicating the group of predetermined devices 20 controlled together with the withdrawal target device and control pattern setting information indicating the details of an operation when a predetermined control signal is acquired.

Although the processing in step S04 is performed after the processing in step S03, the processing in step S03 and the processing in step S04 may be performed simultaneously.

When the target of the withdrawal request signal is determined to be another device (No in S02), that is, when the withdrawal target device is determined not to be device 20, outputter 223 transmits the withdrawal request signal via mesh network 40 (S05). Outputter 223 transmits the withdrawal request signal acquired by acquirer 221 via mesh network 40.

In the operation as described above, device 20 can transmit the withdrawal request signal to all devices 20 forming mesh network 40. In this way, it is possible to transmit the withdrawal request signal to the withdrawal target device via mesh network 40, and thus the user can cause device 20 to more easily withdraw from mesh network 40. When withdrawal of the withdrawal target device from mesh network 40 prevents device 20 from communicating with control terminal 30, device 20 attempts to reconstruct mesh network 40 to communicate with control terminal 30. Device 20 as described above can assist mesh network 40 in maintaining a state where information from control terminal 30 can be transmitted to all devices 20 included in mesh network 40.

### Operation Example 1

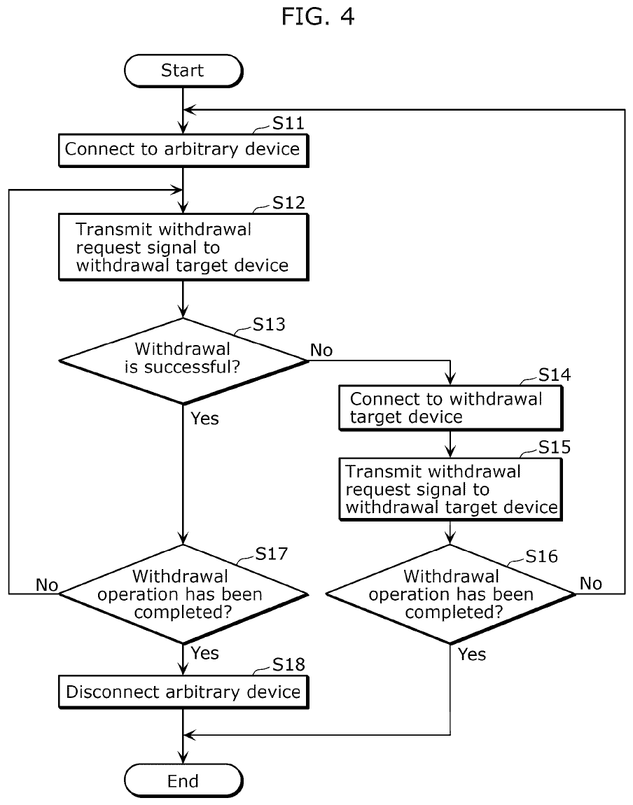

As described above, device 20 can transmit the withdrawal request signal via mesh network 40. By utilizing the function described above, control terminal 30 transmits the withdrawal request signal by the communication via mesh network 40 and the communication performed by direct connection in the two wireless communication modes. Control terminal 30 as described above can cause device 20 to withdraw from mesh network 40 at high speed and more reliably. Operation example 1 of control terminal 30 as described above will be described below. FIG. 4 is a flowchart illustrating operation example 1 of control terminal 30 according to the embodiment.

Control terminal 30 first connects to arbitrary device 20 via wireless communicator 31 (S11). Arbitrary device 20 connected to control terminal 30 is an example of a first device. Wireless communicator 31 of control terminal 30 communicates with wireless communicator 21 of arbitrary device 20 in the second wireless communication mode.

Then, outputter 323 of control terminal 30 transmits the withdrawal request signal to the withdrawal target device (S12). The withdrawal request signal transmitted by outputter 323 is transmitted to the withdrawal target device via wireless communicator 31, wireless communicator 21 of the first device, and mesh network 40. The withdrawal target device is an example of the second device. The withdrawal target device is a device which is caused by the user to withdraw from mesh network 40. The withdrawal request signal is a signal for causing the withdrawal target device to withdraw from mesh network 40, and includes information for identifying the withdrawal target device.

Then, controller 322 determines whether the withdrawal target device has successfully withdrawn (S13). When acquirer 321 acquires the withdrawal success signal, controller 322 determines that the withdrawal target device has successfully withdrawn.

Here, when outputter 223 of device 20 which relays the withdrawal request signal does not acquire the withdrawal success signal from the withdrawal target device, outputter 223 transmits a withdrawal failure signal indicating that the withdrawal target device has failed to withdraw from mesh network 40 to control terminal 30 via mesh network 40. When controller 322 of control terminal 30 acquires the withdrawal failure signal, controller 322 determines that the withdrawal target device has failed to withdraw.

When acquirer 321 has not acquired the withdrawal success signal for a predetermined period, controller 322 may determine that the withdrawal has failed. The predetermined period is, for example, twice the time necessary for the distribution of the withdrawal request signal to entire mesh network 40.

When controller 322 determines that the withdrawal target device has failed to withdraw (No in S13), control terminal 30 connects to wireless communicator 21 of the withdrawal target device via wireless communicator 31 in the second wireless communication mode (S14). The connection of control terminal 30 to the withdrawal target device in the second wireless communication mode may be performed automatically, or may be performed after the confirmation of the user is acquired via operation receiver 34.

Outputter 323 transmits the withdrawal request signal to the withdrawal target device (S15). The withdrawal request signal is transmitted to the withdrawal target device via wireless communicator 31 and wireless communicator 21. Since control terminal 30 connects to the withdrawal target device in the second wireless communication mode, control terminal 30 can cause the withdrawal target device to receive the withdrawal request signal reliably.

In other words, the user connects control terminal 30 and the withdrawal target device in the second wireless communication mode to transmit the withdrawal request signal, and thereby can cause the withdrawal target device to withdraw from mesh network 40 realizably.

Then, controller 322 determines whether a withdrawal operation has been completed (S16). For example, when controller 322 acquires a withdrawal operation completion instruction, controller 322 determines that the withdrawal operation has been completed. Controller 322 causes display 35 to display a screen for causing the user to select whether the withdrawal operation has been completed, causes operation receiver 34 to receive the selection made by the user, and thereby acquires the withdrawal operation completion instruction. For example, when the user has caused all devices 20 which are caused to withdraw from mesh network 40 to withdraw from mesh network 40, the user taps an icon displayed on display 35 to input the withdrawal operation completion instruction. For example, when controller 322 has previously received, from the user, selections for all the withdrawal target devices which are caused to withdraw from mesh network 40, and has acquired the withdrawal success signal from all the withdrawal target devices, controller 322 determines that the withdrawal operation has been completed.

When controller 322 determines that the withdrawal operation has not been completed (No in S16), the process returns to the processing in step S11, and thus control terminal 30 connects to arbitrary device 20 via wireless communicator 31 in the second wireless communication mode (S11). Thereafter, the withdrawal request signal is transmitted to another withdrawal target device via mesh network 40. When controller 322 determines that the withdrawal operation has been completed (Yes in S16), control terminal 30 completes the operation.

When controller 322 determines that the withdrawal target device has successfully withdrawn (Yes in S13), controller 322 determines whether the withdrawal operation has been completed (S17). When controller 322 determines that the withdrawal operation has not been completed (No in S17), the process returns to the processing in step S12, and thus outputter 323 of control terminal 30 transmits the withdrawal request signal to another withdrawal target device (S12). When controller 322 determines that the withdrawal operation has been completed (Yes in S17), wireless communicator 31 of control terminal 30 disconnects the communication with arbitrary device 20 (S18), and thus control terminal 30 completes the operation.

In operation example 1 as described above, control terminal 30 transmits the withdrawal request signal by the communication via mesh network 40 and the communication performed by direct connection in the two wireless communication modes. In communication system 10 as described above, the user can cause device 20 to withdraw from mesh network 40 more reliably.

When a plurality of devices 20 are caused to withdraw via mesh network 40, depending on the order of the withdrawal, device 20 may be disadvantageously isolated from mesh network 40. However, in communication system 10 as described above, device 20 which has been isolated can be directly connected in the second wireless communication mode to withdraw.

### Operation Example 2

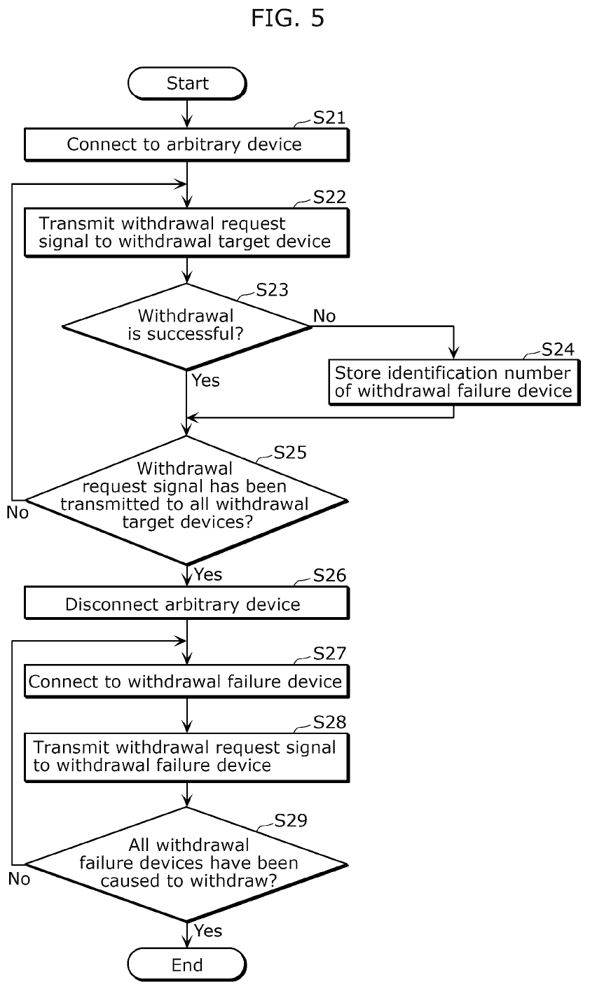

When the user causes a plurality of devices 20 to withdraw from mesh network 40, control terminal 30 stores the identification number of device 20 which has attempted to withdraw via mesh network 40 but has failed to withdraw, and thus it is possible to reduce the number of times control terminal 30 and device 20 are connected in the second wireless communication mode. Operation example 2 of control terminal 30 as described above will be described below. FIG. 5 is a flowchart illustrating operation example 2 of control terminal 30 according to the embodiment.

Control terminal 30 first connects to arbitrary device 20 via wireless communicator 31 (S21). Wireless communicator 31 of control terminal 30 communicates with wireless communicator 21 of arbitrary device 20 in the second wireless communication mode.

Then, outputter 323 of control terminal 30 transmits the withdrawal request signal to the withdrawal target device (S22). The withdrawal request signal transmitted by outputter 323 is transmitted to the withdrawal target device via wireless communicator 31, wireless communicator 21 of the first device, and mesh network 40. The withdrawal request signal includes information for identifying the withdrawal target device, and the information for identifying the withdrawal target device is, for example, the identification number of the withdrawal target device.

Then, controller 322 determines whether the withdrawal target device has successfully withdrawn (S23). For example, when acquirer 321 acquires the withdrawal success signal, controller 322 determines that the withdrawal target device has successfully withdrawn, and when acquirer 321 acquires the withdrawal failure signal, controller 322 determines that the withdrawal target device has failed to withdraw.

When controller 322 determines that the withdrawal target device has failed to withdraw (No in S23), controller 322 stores the identification number of a withdrawal failure device in storage 33 (S24). The withdrawal failure device is a device among withdrawal target devices which has failed to withdraw using the withdrawal request signal transmitted via mesh network 40.

When controller 322 determines that the withdrawal target device has successfully withdrawn (Yes in S23), or when the identification number of the withdrawal failure device is stored, controller 322 determines whether the withdrawal request signal has been transmitted to all the withdrawal target devices via mesh network 40 (S25). For example, controller 322 causes display 35 to display a screen for causing the user to select whether the withdrawal request signal has been transmitted to all the withdrawal target devices, causes operation receiver 34 to receive the selection made by the user, and thereby determines whether the withdrawal request signal has been transmitted to all the withdrawal target devices. For example, controller 322 has previously received selections for all the withdrawal target devices which are caused to withdraw from mesh network 40, and determines, based on the selections, whether the withdrawal request signal has been transmitted to all the withdrawal target devices via mesh network 40.

When controller 322 determines that the withdrawal request signal has not been transmitted to all the withdrawal target devices (No in S25), the process returns to the processing in step S22, and thus the withdrawal request signal is transmitted to the withdrawal target device via mesh network 40.

When controller 322 determines that the withdrawal request signal has been transmitted to all the withdrawal target devices (Yes in S25), wireless communicator 31 of control terminal 30 disconnects arbitrary device 20 (S26).

Then, wireless communicator 31 of control terminal 30 connects to one wireless communicator 21 among one or more withdrawal failure devices in the second wireless communication mode (S27).

Outputter 323 transmits the withdrawal request signal to the withdrawal failure device (S28). The withdrawal request signal is transmitted to the withdrawal failure device via wireless communicator 31 and wireless communicator 21. Since control terminal 30 connects to the withdrawal failure device in the second wireless communication mode, control terminal 30 can cause the withdrawal failure device to receive the withdrawal request signal reliably.

In other words, the user connects control terminal 30 and the withdrawal failure device in the second wireless communication mode to transmit the withdrawal request signal, and thereby can cause the withdrawal failure device to withdraw from mesh network 40 realizably.

When controller 322 causes the withdrawal failure device to withdraw, controller 322 determines whether all the withdrawal failure devices have been caused to withdraw (S29). For example, controller 322 references the identification numbers of the withdrawal failure devices stored in storage 33 to determine whether all the withdrawal failure devices have been caused to withdraw.

When controller 322 determines that all the withdrawal failure devices have not been caused to withdraw (No in S29), the process returns to the processing in step S27, and thus control terminal 30 connects to one of the withdrawal failure devices in the second wireless communication mode.

When controller 322 determines that all the withdrawal failure devices have been caused to withdraw (Yes in S29), control terminal 30 completes the operation.

When no withdrawal failure device is present, control terminal 30 completes the operation without performing the processing in steps S27 to S29.

In operation example 2 as described above, control terminal 30 stores the identification numbers of devices 20 which have failed to withdraw, and thus control terminal 30 transmits the withdrawal request signal to a plurality of devices 20 via mesh network 40, and then directly connects to each of devices 20 which have failed to withdraw to be able to transmit the withdrawal request signal. In communication system 10 as described above, the user can cause devices 20 to more easily withdraw from mesh network 40.

### Variation

Control terminal 30 can previously receive, from the user, selections for a plurality of withdrawal target devices which are caused to withdraw from mesh network 40. In a case where a plurality of withdrawal target devices are caused to withdraw, if device 20 being directly connected is included in the withdrawal target devices, when device 20 withdraws from mesh network 40, the other withdrawal target devices cannot be caused to withdraw via mesh network 40. The operation of a variation of control terminal 30 which can cause device 20 to more easily withdraw from mesh network 40 even in such conditions will be described below.

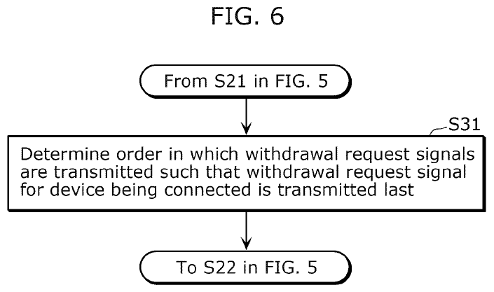

FIG. 6 is a flowchart illustrating the operation of the variation of control terminal 30 according to the embodiment. FIG. 6 shows an operation which is performed when control terminal 30 receives selections for a plurality of withdrawal target devices from the user, and device 20 being directly connected is included in the withdrawal target devices. Control terminal 30 first performs the processing in step S21 shown in FIG. 5. In other words, control terminal 30 connects to arbitrary device 20 via wireless communicator 31.

Then, controller 322 determines an order in which one or more withdrawal request signals are transmitted such that the withdrawal request signal for device 20 being connected is transmitted last (S31).

Outputter 323 of control terminal 30 performs the processing in step S22 shown in FIG. 5 according to the order in which the withdrawal request signals are transmitted and which is determined by controller 322. In other words, outputter 323 transmits the withdrawal request signals to the withdrawal target devices according to the order in which the withdrawal request signals are transmitted and which is determined by controller 322. In this case, the processing in step S26, that is, the processing in which wireless communicator 31 of control terminal 30 disconnects arbitrary device 20 is not performed because arbitrary device 20 (device 20 being directly connected) has withdrawn from mesh network 40 before the process proceeds to step S26.

In the variation described above, step S21 shown in FIG. 5 may be replaced by step S11 shown in FIG. 4, and step S22 shown in FIG. 5 may be replaced by step S12 shown in FIG. 4. In this case, when controller 322 determines that the withdrawal target device has failed to withdraw using the withdrawal request signal via mesh network 40 (No in S13 shown in FIG. 4), before the connection to device 20 being connected is disconnected, the withdrawal request signal is transmitted to device 20 being connected, and thus device 20 being connected is caused to withdraw from mesh network 40 so that control terminal 30 connects to the withdrawal target device via wireless communicator 31 in the second wireless communication mode (S14 in FIG. 4).

In the operation as described above, device 20 to which control terminal 30 connects is caused to withdraw, and thus it is possible to suppress the incapability of causing devices 20 which are not directly connected to control terminal 30 to withdraw via mesh network 40, with the result that it is possible to reduce the number of times control terminal 30 and arbitrary device 20 are directly connected in the second wireless communication mode. Hence, the user can cause devices 20 to more easily withdraw from mesh network 40.

### Effects and Like

Examples of techniques derived from the disclosure of the present specification include the following techniques. The techniques derived from the disclosure of the present specification will be described below together with effects and the like obtained by the techniques.

Technique 1 is communication system 10 including: a plurality of devices 20 that form mesh network 40, and perform wireless communication in a first wireless communication mode in mesh network 40; and control terminal 30, control terminal 30: connects to a first device among the plurality of devices 20 by wireless communication in a second wireless communication mode different from the first wireless communication mode; and transmits, to the first device, a withdrawal request signal for causing a second device different from the first device among the plurality of devices 20 to withdraw from mesh network 40, and when the second device receives the withdrawal request signal from the first device via mesh network 40, the second device withdraws from mesh network 40.

Communication system 10 as described above can transmit, while connecting to arbitrary one device 20, the withdrawal request signal to the plurality of devices 20 via mesh network 40. In other words, communication system 10 can transmit, via mesh network 40, the withdrawal request signal to devices 20 which are not directly connected to control terminal 30. Hence, communication system 10 as described above can cause devices 20 to more easily withdraw from mesh network 40.

In technique 2 which is communication system 10 of technique 1, when the second device fails to withdraw from mesh network 40, control terminal 30 connects to the second device by the wireless communication in the second wireless communication mode, and transmits the withdrawal request signal to the second device.

In communication system 10 as described above, control terminal 30 transmits the withdrawal request signal by the communication via mesh network 40 and the communication performed by direct connection in the two wireless communication modes. In communication system 10 as described above, the user can cause device 20 to withdraw from mesh network 40 more reliably.

In technique 3 which is communication system 10 of technique 1 or 2, when the second device fails to withdraw from mesh network 40, control terminal 30 stores identification information of the second device.

In communication system 10 as described above, when the user causes a plurality of devices 20 to withdraw from mesh network 40, if devices 20 have failed to withdraw using the withdrawal request signal transmitted via mesh network 40, control terminal 30 stores the identification numbers of devices 20 which have failed to withdraw, and thus control terminal 30 transmits the withdrawal request signal to devices 20 via mesh network 40, and then directly connects to each of devices 20 which have failed to withdraw to be able to transmit the withdrawal request signal. In communication system 10 as described above, the user can cause devices 20 to more easily withdraw from mesh network 40.

In technique 4 which is communication system 10 of any one of techniques 1 to 3, when withdrawal of the second device from mesh network 40 prevents each of the plurality of devices 20 from communicating with control terminal 30, the device reconstructs mesh network 40 to communicate with control terminal 30.

Communication system 10 as described above can assist mesh network 40 in maintaining a state where information from control terminal 30 can be transmitted to all devices 20 included in mesh network 40.

In technique 5 which is communication system 10 of any one of techniques 1 to 4, control terminal 30 further transmits, by the wireless communication in the second wireless communication mode, a first device withdrawal request signal for causing the first device to withdraw from the mesh network. In communication system 10 as described above, it is possible to cause devices 20 which are directly connected to control terminal 30 to withdraw from mesh network 40.

In technique 6 which is communication system 10 of technique 5, when control terminal 30 transmits the first device withdrawal request signal, if the second device to be withdrawn is present, control terminal 30 transmits the withdrawal request signal before transmitting the first device withdrawal request signal.

In communication system 10 as described above, device 20 to which control terminal 30 connects is caused to withdraw, and thus it is possible to suppress the incapability of causing devices 20 which are not directly connected to control terminal 30 to withdraw via mesh network 40

In technique 7 which is communication system 10 of any one of techniques 1 to 6, the plurality of devices 20 include a lighting device which includes a wireless communication function.

In communication system 10 as described above, the user can cause the lighting device to more easily withdraw from mesh network 40.

Technique 8 is control terminal 30 including: wireless communicator 31; and controller 322, and using wireless communicator 31, controller 322: connects to a first device among a plurality of devices 20 by wireless communication in a second wireless communication mode different from a first wireless communication mode, the plurality of devices 20 forming mesh network 40 and performing wireless first communication in the wireless communication mode in mesh network 40; and transmits, to the first device, a withdrawal request signal for causing a second device different from the first device among the plurality of devices 20 to withdraw from mesh network 40.

In control terminal 30 as described above, the user can cause devices 20 to more easily withdraw from mesh network 40.

Technique 9 is a control method including: connecting, by control terminal 30, to a first device among a plurality of devices 20 by wireless communication in a second wireless communication mode different from a first wireless communication mode, the plurality of devices 20 forming mesh network 40 and performing wireless communication in the first wireless communication mode in mesh network 40; transmitting, by control terminal 30, to the first device, a withdrawal request signal for causing a second device different from the first device among the plurality of devices 20 to withdraw from mesh network 40; and withdrawing, by the second device, from mesh network 40 when the second device receives the withdrawal request signal from the first device via mesh network 40.

In the control method as described above, it is possible to transmit the withdrawal request signal to devices 20 which are not directly connected to control terminal 30 via mesh network 40. Hence, in the control method as described above, the user can cause devices 20 to more easily withdraw from mesh network 40.

Technique 10 is a non-transitory computer-readable recording medium having stored therein a program for causing control terminal 30 and the second device to perform the control method of technique 9.

The recording medium as described above can assist in causing devices 20 to more easily withdraw from mesh network 40.

Technique 11 is a control method that is performed by control terminal 30, and the control method includes: connecting to a first device among a plurality of devices 20 by wireless communication in a second wireless communication mode different from a first wireless communication mode, the plurality of devices 20 forming mesh network 40 and performing wireless communication in the first wireless communication mode in mesh network 40; and transmitting, to the first device, a withdrawal request signal for causing a second device different from the first device among the plurality of devices 20 to withdraw from mesh network 40.

In the control method as described above, control terminal 30 can transmit the withdrawal request signal to devices 20 which are not directly connected to control terminal 30 via mesh network 40. Hence, in the control method as described above, the user can use control terminal 30 to cause devices 20 to more easily withdraw from mesh network 40.

Technique 12 is a non-transitory computer-readable recording medium having stored therein a program for causing a computer to execute the control method of technique 11.

The recording medium as described above can assist the user in using control terminal 30 to cause devices 20 to more easily withdraw from mesh network 40.

### OTHER EMBODIMENTS

Although the embodiment has been described above, the present disclosure is not limited to the embodiment described above. The communication method between the devices described in the embodiment is an example. The communication method between the devices is not particularly limited.

In the embodiment described above, processing which is executed by a specific processor may be executed by another processor. The order of a plurality of processing steps may be changed, or a plurality of processing steps may be executed in parallel.

In the embodiment described above, constituent elements such as the controller may be realized by executing a software program suitable for each of the constituent elements. A program executer such as a CPU or a processor may read and execute a software program recorded in a recording medium such as a hard disk or a semiconductor memory to realize each of the constituent elements.

The constituent elements such as the controller may be realized by hardware. For example, the constituent elements such as the controller may be circuits (or integrated circuits). These circuits may form one circuit as a whole, or may be separate circuits. Each of these circuits may be a general-purpose circuit or a dedicated circuit.

A general or specific form of the present disclosure may be realized by a system, a device, a method, an integrated circuit, a computer program, or a computer-readable recording medium such as a CD-ROM. The general or specific form may be realized by any combination of a system, a device, a method, an integrated circuit, a computer program, and a recording medium. For example, the present disclosure may be realized as the communication system or the information terminal in the embodiment described above, or may be realized as an information processing method executed by the information terminal. The present disclosure may be realized as a program for causing a computer to execute the information processing method as described above, or may be realized as a non-transitory recording medium in which the program as described above is recorded. The program as described above includes an application program for causing a computer such as a general-purpose information terminal to function as the information terminal in the embodiment described above.

Embodiments obtained by performing various types of variations conceivable by those skilled in the art on the embodiments and embodiments realized by arbitrarily combining constituent elements and functions in the embodiments without departing from the spirit of the present disclosure are also included in the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A communication system comprising:
a plurality of devices that form a mesh network, and perform wireless communication in a first wireless communication mode in the mesh network; and
a control terminal,
wherein the control terminal:
connects to a first device among the plurality of devices by wireless communication in a second wireless communication mode different from the first wireless communication mode; and
transmits, to the first device, a withdrawal request signal for causing a second device different from the first device among the plurality of devices to withdraw from the mesh network, and
when the second device receives the withdrawal request signal from the first device via the mesh network, the second device withdraws from the mesh network.

2. The communication system according to claim 1,
wherein when the second device fails to withdraw from the mesh network, the control terminal connects to the second device by the wireless communication in the second wireless communication mode, and transmits the withdrawal request signal to the second device.

3. The communication system according to claim 1,
wherein when the second device fails to withdraw from the mesh network, the control terminal stores identification information of the second device.

4. The communication system according to claim 1,
wherein when withdrawal of the second device from the mesh network prevents each of the plurality of devices from communicating with the control terminal, the device reconstructs the mesh network to communicate with the control terminal.

5. The communication system according to claim 1,
wherein the control terminal further transmits, by the wireless communication in the second wireless communication mode, a first device withdrawal request signal for causing the first device to withdraw from the mesh network.

6. The communication system according to claim 5,
wherein when the control terminal transmits the first device withdrawal request signal, if the second device to be withdrawn is present, the control terminal transmits the withdrawal request signal before transmitting the first device withdrawal request signal.

7. The communication system according to claim 1,
wherein the plurality of devices include a lighting device which includes a wireless communication function.

8. A control terminal comprising:
a wireless communicator; and
a controller,
wherein using the wireless communicator, the controller:
connects to a first device among a plurality of devices by wireless communication in a second wireless communication mode different from a first wireless communication mode, the plurality of devices forming a mesh network and performing wireless communication in the first wireless communication mode in the mesh network; and
transmits, to the first device, a withdrawal request signal for causing a second device different from the first device among the plurality of devices to withdraw from the mesh network.

9. A control method comprising:
connecting, by a control terminal, to a first device among a plurality of devices by wireless communication in a second wireless communication mode different from a first wireless communication mode, the plurality of devices forming a mesh network and performing wireless communication in the first wireless communication mode in the mesh network;
transmitting, by the control terminal, to the first device, a withdrawal request signal for causing a second device different from the first device among the plurality of devices to withdraw from the mesh network; and
withdrawing, by the second device, from the mesh network when the second device receives the withdrawal request signal from the first device via the mesh network.

10. A non-transitory computer-readable recording medium having stored therein a program for causing the control terminal and the second device to perform the control method according to claim 9.

11. A control method that is performed by a control terminal, the control method comprising:
connecting to a first device among a plurality of devices by wireless communication in a second wireless communication mode different from a first wireless communication mode, the plurality of devices forming a mesh network and performing wireless communication in the first wireless communication mode in the mesh network; and
transmitting, to the first device, a withdrawal request signal for causing a second device different from the first device among the plurality of devices to withdraw from the mesh network.

12. A non-transitory computer-readable recording medium having stored therein a program for causing a computer to execute the control method according to claim 11.
